(19) United States
(12) Patent Application Publication
(10) Pub. No.: US 2008/0202991 A1
(43) Pub. Date: Aug. 28, 2008

(54) APPARATUS AND METHOD FOR CHEMICAL ADDITION TO SLURRY

(76) Inventor: James E. Meagher, Cape Elizabeth, ME (US)

Correspondence Address: CHRIS A. CASEIRO, VERRILL DANA, LLP, ONE PORTLAND SQUARE, PORTLAND, ME, 04112-0586, US

(21) Appl. No.: 11/679,821

(22) Filed: Feb. 27, 2007

(51) Int. Cl. C02F 11/00

(52) U.S. Cl. 210/85

(57) ABSTRACT

An apparatus and related method for introducing chemical treatment to a slurry. The apparatus includes a manifolded conduit for receiving and transferring slurry, a chemical treatment pump for regulated introduction of one or more chemicals to the slurry in the conduit, a controller unit, and a chemical treatment mixing tank. The chemical treatment apparatus may be stationary or located on a portable transport. The controller unit includes a programmable logic controller arranged to calculate suitable chemical treatment introduction parameters from meter information associated with the slurry flow. The programmable logic controller is further programmed to control operation of the chemical treatment pump and any slurry mixers to optimize slurry treatment, such as flocculation.

### BACKGROUND OF THE INVENTION

1. Field of the Invention

The present invention relates to devices and methods for adding chemical treatments to slurries. More particularly, the present invention relates to the addition of chemical treatments to a slurry in a continuous process prior to dewatering to facilitate the separation of the solids and liquids that constitute the slurry. The present invention combines slurry sensing and chemical additive flow control devices to enable rapid responses to slurry content changes.

2. Description of the Prior Art

A wide variety of situations exist in which one or more solids and one or more liquids combine to form a slurry. That is, the condition when the solid(s) is/are suspended in the liquid(s). It may be of interest to separate the solid from the liquid in the slurry in order to perform further steps or use either or both in subsequent actions. For example, when water bodies are dredged wherein solids are removed from the bottom, it may be necessary to separate the water and suspended solid material from each other for treatment of either or both, return of the water to its origin, and/or relocation of the solid material.

Current solids dewatering systems used in separating water from the solids removed from water bodies in dredging projects are generally batch operations. The slurry of water and solids is directed to a dewatering filter, such as the Geotube® product from TenCate Geosynthetics of the Nicolon corporation with an address of Commerce Ga. The dewatering filter screens out solids using a containment unit formed of textile material, which allows water to pass therethrough. The solids are retained in the containment unit for subsequent removal. The water exiting through pores of the containment unit are captured and returned to the water body, typically after testing for contaminants.

In order to facilitate or enhance the dewatering process, dredging operations may include the introduction of chemical treatments to improve the separation process. Specifically, the chemical treatment is added to the slurry prior to introduction of the slurry to the containment unit of the dewatering system. In many instances, the content of the slurry varies in the course of a dredging project and it can be difficult to regulate the chemical treatment introduction to increase the effectiveness of the containment unit. The effectiveness of the treatment is only determined after the dewatering process when testing of the water effluent occurs. The chemical treatments include one or more polymeric flocculuants, which are high molecular-weight organic compounds. They may be applied to the slurry alone or in combination with other coagulation compounds. For example, polyelectrolytes may be used in very small doses. The present invention contemplates the use of such types of chemical treatments.

An associated limitation of existing dewatering systems in which chemical treatments are used is the time required to perform the dewatering. Since it is desirable and often required to improve the water quality, it is important to ensure that the chemical treatment is appropriate. As a result, the dewatering process tends to be, effectively, a batch operation. That is, the chemical treatment is introduced to the slurry in a quantity considered to be suitable, the output effluent is tested for quality, and the chemical treatment adjusted in a trial-and-error method until the output is deemed satisfactory. Any change of the content of the slurry may render the existing chemical treatment introduction protocol obsolete. The dewatering process, and therefore ordinarily the dredging process, must be halted and the trial-and-error method repeated until the output effluent is again satisfactory.

What is needed is a chemical treatment apparatus and related method for treating a slurry to enhance subsequent solids separation steps while minimizing down time. In particular, what is needed is a chemical treatment apparatus and related method to evaluate the slurry and respond rapidly to changes thereto with adjustments of the chemical treatment while the slurry continues its passage to the solids separation stage.

### SUMMARY OF THE INVENTION

It is an object of the present invention to provide a chemical treatment apparatus and related method for treating a slurry to enhance subsequent solids separation steps while minimizing down time. It is also an object of the present invention to provide a chemical treatment apparatus and related method to evaluate the slurry and respond rapidly to changes thereto with adjustments of the chemical treatment while the slurry continues its passage to the solids separation stage. It is a particular object of the present invention to provide an apparatus and related method for introducing chemical treatments to the slurries associated with dredging operations prior to introduction of the slurry to a dewatering containment unit.

These and other objects are achieved with the present invention, which combines sensors (otherwise referred to herein as meters) to provide feedback information, mechanical components to enable the adjustable flow of chemical treatments to a slurry, and a controller to regulate the chemical treatment introduction to the slurry based upon the feedback information. In particular, the invention is a chemical feed system and related method for the collection of slurry and chemical treatment data obtained from a plurality of meters, and a mechanism to compute and control chemical dosing rate to the slurry in real time.

The system includes a programmable logic controller (PLC) to collect electronic signals from meters in a format that enables carrying out of mathematical computations resulting in information that defines the operation of a chemical dose pump to ensure that the slurry characteristics are suitable for introduction of the slurry to a downstream dewatering system. As is known, a PLC is a programmable microprocessor-based device that can be used in discrete operations to receive and evaluate information and control the operation of devices. The PLC is designed for real-time use in a wide range of environments. The PLC used for the present invention includes enough input/output ports of selectable scan rate to connect to all meters and device actuators associated with the apparatus of the present invention.

The PLC is configured at least to obtain from the meters readings of percent of dry solids in the slurry and rate of flow of the slurry out of the present system after treatment at a selectable periodic or sporadic rate. For example, measurements may be taken about every 15 seconds. The meters are arranged to output electrical signals in a scaled format that permits the calculation of the amount of dry solids in the slurry in accordance with Equation (1):

flow gpm×% percent of dry solids×density=dry pounds of solid Eq. (1)

The related method of the present invention includes the step of designating specific “tags” associated with each meter and each pump regulator. The PLC is electrically coupled to each tagged metering and actuation device for receiving and/or transmitting signals. The PLC is programmed using software programming methods known to those of ordinary skill in the art to collect scaled signal information from the meters, which meters interface with the slurry flowing through one or more conduits. For example, a flow meter using Doppler technology detects and transmits a signal to the PLC for the slurry flow mass passing through the conduit. A second meter that transmits and receives microwaves is used to transmit electrical signals corresponding to the measure of solids on a dry weight basis passing through a conduit. An assumed value of density is used based on the product type being processed and, optionally, by direct testing a batch of the product prior to treatment. Based on the noted information, the PLC can effectively calculate the amount, by weight, of dry solids suspended in the slurry passing through the conduit.

The calculated dry solids value is then used to calculate the amount of chemical treatment material, which chemical treatment material may be one or more polymers including, but not limited to, synthetic polyelectrolytes classified on the basis of the type of charge of the polymer chain. Negatively charged polymers are classified as anionic and positively charged polymers are classified as cationic. That material is added to the slurry in order to cause flocculation of the suspended solids therein. The particular chemical treatment is preferably selected based upon the type of solids suspended in the slurry and the extent of flocculation desired to maximize the effectiveness of the downstream dewatering system. In particular, the calculated dry solids content is used to calculate the required amount by volume of chemical treatment to be added to the slurry. In simple form, that calculation is that chemical treatment addition is the percent of lbs of polymer per lbs of dry solids. That is, based on the known lbs of dry solids going through the conduit, the PLC is them used to calculate the volume of chemical treatment needed to correctly dose the slurry to produce the desired solids flocculation at the output of the apparatus of the present invention.

After determining the proper amount of chemical treatment to apply, the PLC is configured to send a scaled electrical signal to a chemical treatment pump that may be of variable speed. For example, the chemical treatment pump may be controlled by a variable frequency drive (VFD) that is controlled by the PLC. In that way, the PLC may be used to regulate the flow of chemical treatment into the slurry by regulating the rate of speed of the pump. The chemical treatment may be added directly to the slurry, or more preferably, it may be combined with a fluid, such as the effluent from the dewatering system but not limited thereto, to dilute the chemical treatment and enhance its interaction with the slurry. In particular, the present invention includes a dilution flow meter for measuring and regulating fluid mixing with the chemical treatment, and a proportional mixing valve controllable to regulate fluid introduction to the chemical treatment.

The present invention further includes an inline static mixer having a fixed-position mixing plate and a variable-position mixing plate. The inline static mixer is used to disperse the chemical treatment, diluted or undiluted as desired, with the slurry in the conduit. A variable position controller is used to position the variable-position mixing plate in the slurry stream as desired. Specifically, it is controlled through a scaled signal from the PLC and its positioning and the mixing rate may be regulated based on the chemical treatment flow rate from the VFD-controlled chemical treatment pump. The apparatus further includes optional downstream meters, such as for observing pH, conduit or manifold pressure changes, or pump changes. Based on the outputs from these downstream meters, the PLC may act to adjust upstream options, or signal to an operator, either located at the site of the apparatus or remotely, to change or halt operations.

These and other advantages and features of the present invention will become apparent upon reviewing of the following detailed description, the accompanying drawings and the appended claims.

### BRIEF DESCRIPTION OF THE DRAWINGS

FIG. 1 is a diagrammatic representation of a dewatering system including the chemical treatment apparatus of the present invention.

FIG. 2 is a plan view of the chemical treatment apparatus of the present invention as contained in a portable trailer.

FIG. 3 is a first schematic representation of the slurry treatment conduit of the chemical treatment apparatus.

FIG. 4 is a second schematic representation of the slurry treatment conduit of the chemical treatment apparatus.

FIG. 5 is a flow diagram of the slurry flow and chemical treatment process of the present invention.

FIG. 6 is a schematic representation of the control system of the chemical treatment process of the present invention.

FIG. 7 is a first screen capture of a graphical user interface for observing meter readings and controlling chemical treatment introduction.

FIG. 8 is a second screen capture of a graphical user interface for observing meter readings and controlling chemical treatment introduction.

### DETAILED DESCRIPTION OF THE PREFERRED EMBODIMENT

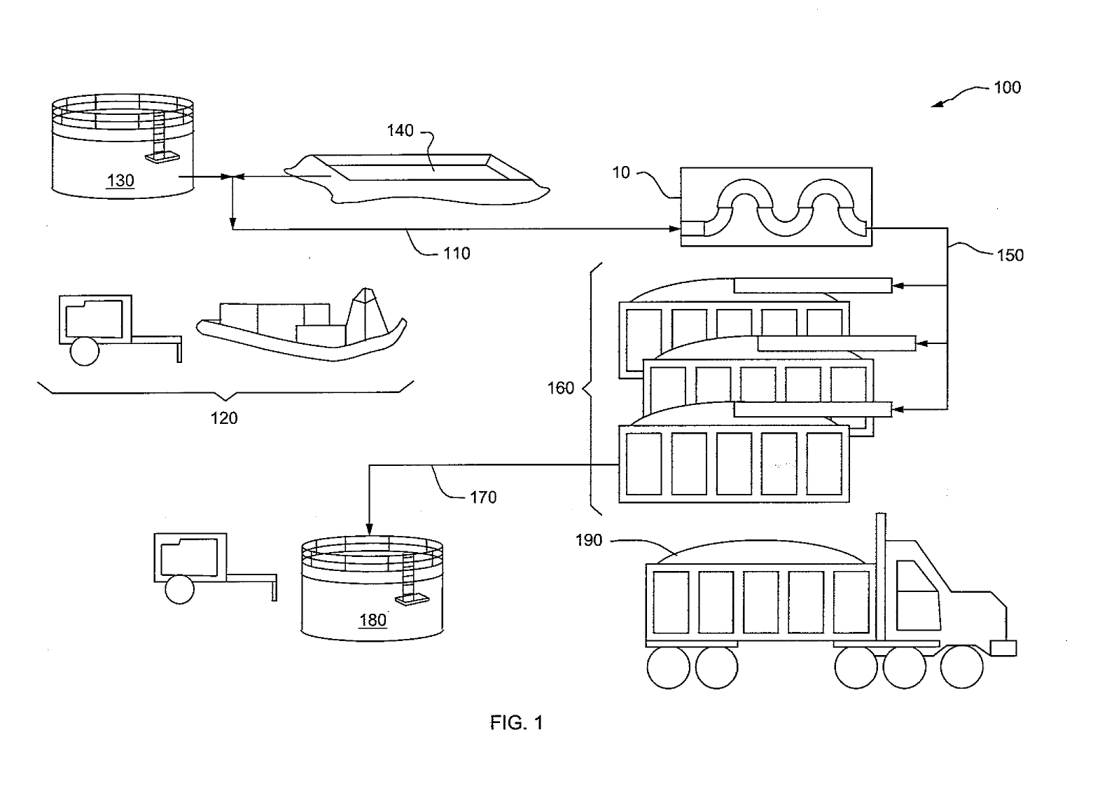

As shown in FIG. 1, the present invention is a chemical treatment apparatus 10 arranged to provide intermediate treatment to a slurry comprising one or more fluids and one or more suspended solids. In the representation of a slurry dewatering system 100 shown in FIG. 1, an untreated slurry represented by line 10 generated using a solids removal system 120, such as a dredge or a pump is transferred either directly from the solids removal system 120 or from a preliminary settling stage, such as a holding tank 130 or a settling pond 140, to the chemical treatment apparatus 10. Chemically treated slurry, represented by line 150, is transferred from the chemical treatment apparatus to a dewatering system 160. The dewatering system 160 is used to substantially separate the one or more solids from the one or more fluids to produce an effluent, represented by line 170. The effluent may be transferred to an effluent retention container 180 for subsequent use or return to the site of the solids removal stage at solids removal system 120. Solids retained within the dewatering system 160 may be accumulated and then removed from the site using a truck 180, for example, or other suitable hauling means.

Although the chemical treatment apparatus 10 has been described with reference to FIG. 1 in the context of a dredged solids dewatering system in which suspended solids that may have been removed from a body of water are separated from water, it is to be understood that the invention may be used in other suspended solids removal systems and therefore is not intended to be limited to that application alone. It is also to be noted that the chemical treatment may involve the introduction of any one or more selectable chemicals suitable for increasing the effectiveness of the solids separation process. For example, the chemical may be of any type or types useful in clumping together suspended solids to enhance the physical filtration process occurring downstream from the chemical treatment apparatus 10.

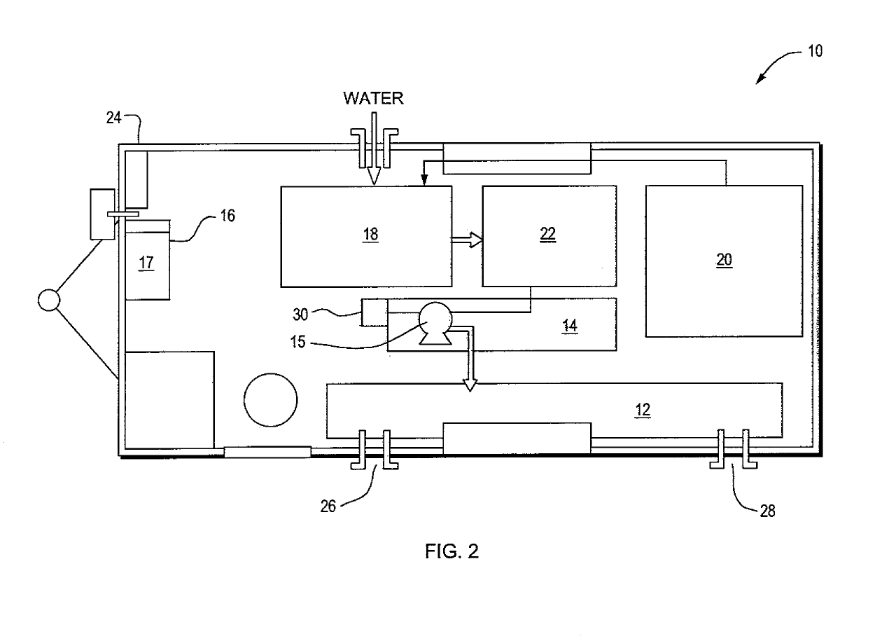

With reference to FIG. 2, the chemical treatment apparatus 10 a manifolded conduit unit 12, a chemical treatment pump unit 14, a controller unit 16, a chemical preparation system for dilution of polymer 18, a chemical storage container for concentrated polymer 20, and a dilution chemical treatment storage tank 22, preferably arranged for detention of the chemical treatment for a selectable period of time, such as about 30 minutes, for example. The chemical treatment apparatus 10 may be a combination of each of these components as stand-alone devices. Alternatively, it may be established as a permanent set of stations in a facility, or it may be the combination of the identified units contained in a portable container device, such as a trailer 24. The conduit unit 12 includes a primary inlet 26 for receiving the untreated slurry from an upstream source, and a primary outlet 28 for transmitting treated slurry to a downstream dewatering apparatus.

In operation, an optional first step is to characterize the untreated slurry for the purpose of determining what type and level of chemical treatment is to be added to the untreated slurry to improve its characteristics for the purpose of subsequent dewatering. That may be achieved by taking samples and running experimental batches through the chemical treatment apparatus 10 or at an offsite location in a pilot reaction device. Based on the results of that initial characterization, the controller unit 16 including a PLC 17 may be programmed to establish operating parameters of the chemical treatment pump unit 14. The PLC 17 may be a programmable logic controller available from Micrologic and incorporating a sufficient number of input and output ports for the purpose of the present invention.

Upon completion of the PLC 17 programming using suitable hardware and applicable software, one or more chemicals from the system 18 and removed from the container 20 are transferred to the chemical treatment mixing aging tank unit 22 in preparation for transfer therefrom by a chemical treatment pump 15 of the chemical treatment pump unit 14 to the conduit unit 12. The chemical treatment pump is preferably a progressive pump, such as a positive displacement pump. The PLC 17 programming includes operation control signals to a variable frequency drive 30 that is coupled to the chemical treatment pump 15. That is, the PLC transmits scaled electrical signals to the variable frequency drive 30 to control the rate at which the chemical treatment pump 15 pumps the chemical treatment from the chemical treatment mixing tank unit 22, which rate is a function of the optional initial characterization and any feedback information received from meters used to monitor the condition of the untreated slurry and the operation of the chemical treatment apparatus 10.

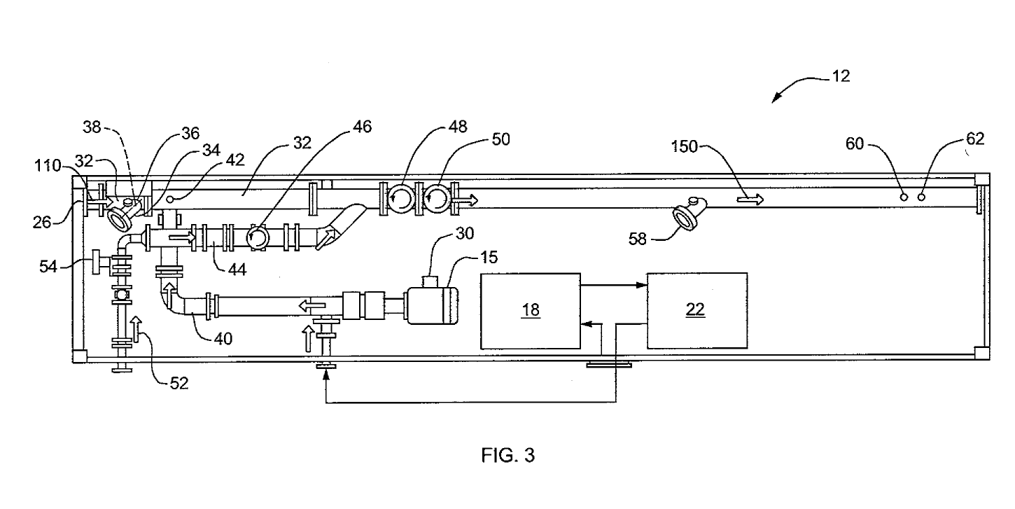

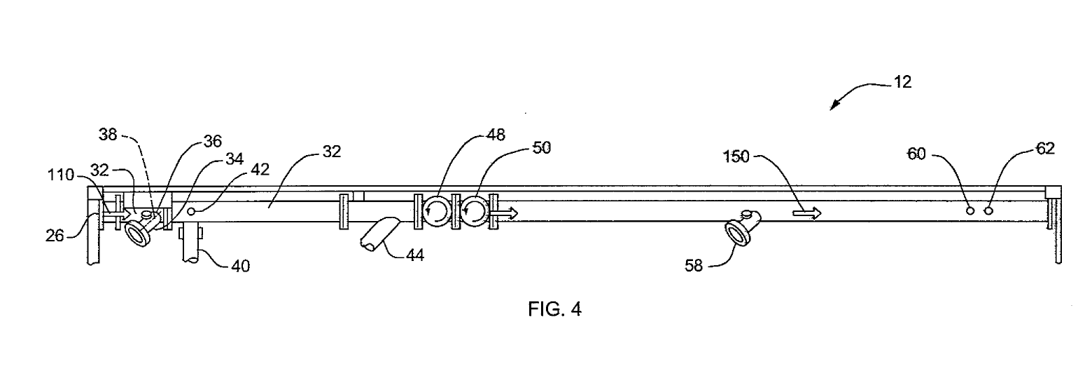

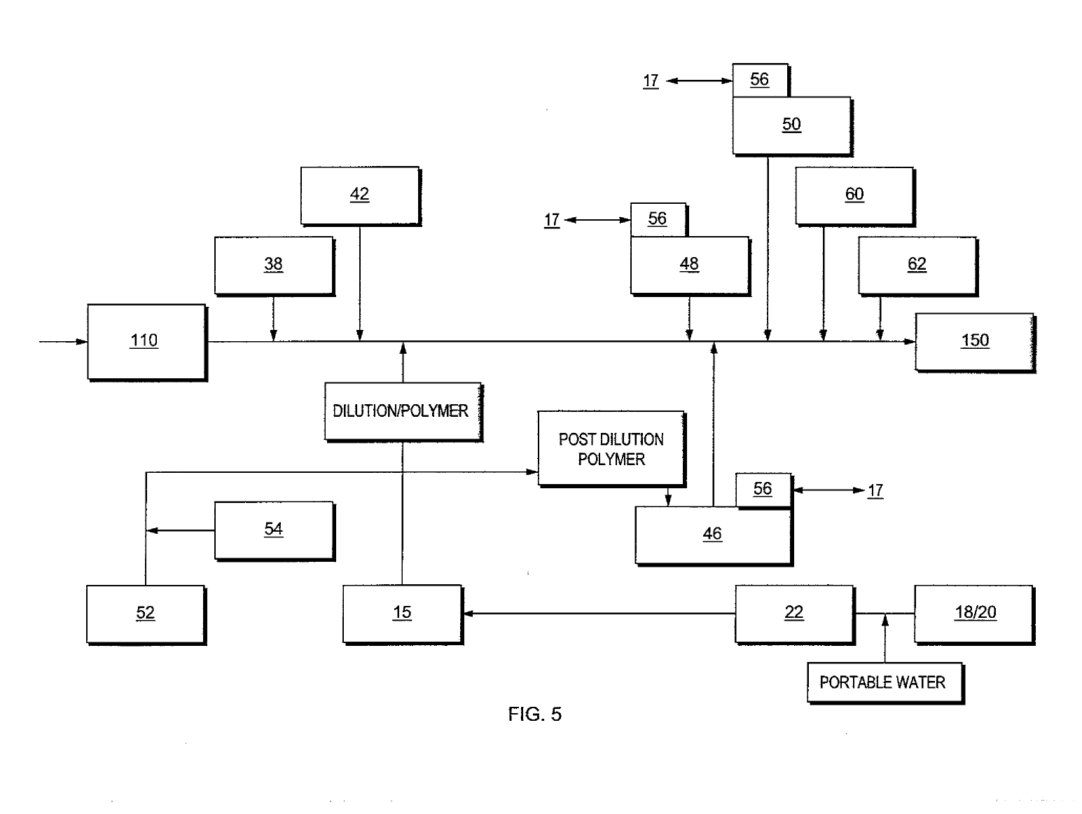

As illustrated in FIGS. 3-5, the conduit unit 12 includes a conduit 32 through which slurry passes between the primary inlet 26 and the primary outlet 28. The conduit may be fabricated of any suitable material of interest including, but not limited to, a metallic material, such as Aluminum, a non-metallic material, such as Polyvinyl Chloride, or a combination of metallic and non-metallic materials. The primary inlet 26 is coupled to an upstream source, such as through a disconnectable pipe, and the primary outlet 28 is coupled to a dewatering unit, also such as through a disconnectable pipe. It is contemplated that the conduit 32 may be supplied by more than one source through more than one inlet, and that the treated slurry may be transferred to more than one downstream location through more than one outlet.

The conduit 32 further includes an optional sampling valve 34 or port to enable removal of untreated slurry 110 for testing of interest, or to otherwise access the interior of the conduit 32 prior to introduction of one or more chemicals. The conduit 32 includes one or more meter ports 36 for passing therethrough one or more flow meters 38 configured to measure flow rate of the slurry through the conduit 32 and to transmit to the PLC 17 electrical signals proportional to slurry flow rate. The conduit 32 also includes a first chemical treatment inlet pipe 40 with accompanying dry solids meter 42 for measuring the level of chemical treatment solids initially introduced to the untreated slurry 110 in the conduit 32. The first chemical treatment inlet pipe 40 is coupled to the chemical treatment mixing tank unit 22 via the chemical treatment pump 15, which regulates the rate at which the chemical treatment is added to the conduit 32 through pipe 40. The chemical treatment transferred via the first chemical treatment inlet pipe 40 may be diluted at an adjustable level of dilution as established by the calculations performed based on the characteristics of the untreated slurry 110.

With continuing reference to FIGS. 3-5, the conduit 32 includes a second chemical treatment inlet pipe 44 and a series of in-line mixers, including a variable aperture mixer 46, such as from Westfall Manufacturing, a vertical path self-cleaning mixer 48, and a horizontal path self-cleaning mixer 50. The second chemical treatment inlet pipe 44 is coupled to a diluting fluid source 52 via a controllable proportional control valve 54, which regulates the rate at which a diluted level of the chemical treatment is added to the conduit 32 through pipe 44. The chemical treatment transferred via the second chemical treatment inlet pipe 44 may be diluted at an adjustable level of dilution as established by the calculations performed based on the characteristics of the untreated slurry 110. In particular, the diluted chemical treatment introduced through the second chemical treatment inlet pipe 44 may perform as a fine tuning tool to tweak the level of chemical treatment introduced to the slurry in the conduit 32 in order to optimize the characteristics of the treated slurry 150 exiting the chemical treatment unit 12.

The conduit 32 optionally includes one or more in-line mixers, such as the variable aperture mixer 46, vertical path self-cleaning mixer 48, and horizontal path self-cleaning mixer 50. There may be more or fewer mixers as desired. One or more of the noted mixers may be a static mixer having a fixed-position mixing plate and/or variable-position mixing plate. A variable position controller 56 electrically coupled to the PLC 17 is used to position any of the mixers operating as a variable-position mixing plate in the slurry stream within the conduit 32 as desired. The in-line mixers are arranged to improve contact between the introduced chemicals and the slurry solids to enhance flocculation, if that is of interest, or other treatment of the slurry as desired. The conduit 32 further and optionally may include a treated slurry sampling valve 58 or port to enable removal of treated slurry 150 for testing of interest, or to otherwise access the interior of the conduit 32 subsequent to introduction of one or more chemicals. Yet further, the conduit 32 may include one or more supplemental meter or sensor ports for introducing therethrough additional metering devices, such as a pressure gage 60, a pH meter 62, or the like.

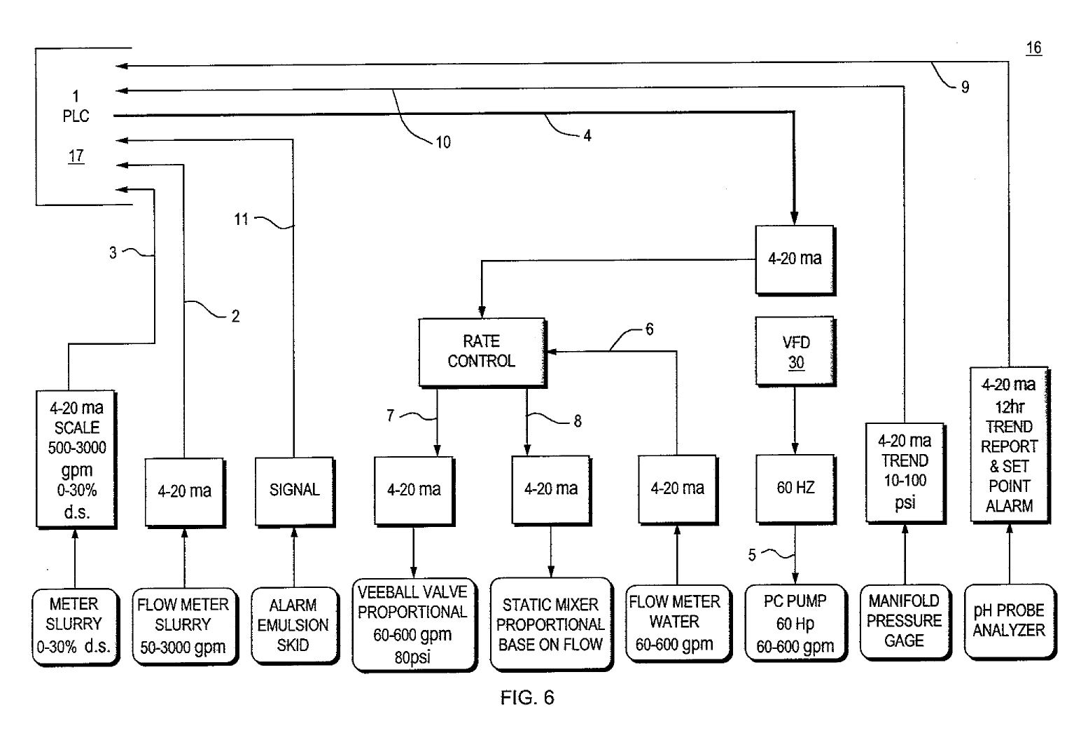

As illustrated in FIG. 6, the controller unit 16 of the chemical treatment apparatus 10 includes the PLC 17, which is programmed via a graphical user interface and one or more input devices, such as a keyboard, a mouse, and/or a touch screen. The controller unit 16 includes a plurality of electrical connections to meters and actuators. The meter connections transfer from the meters and sensors described herein electrical signals proportional to physical characteristics of the slurry, the chemical treatment devices, the mixing and pumping units, and the interior of the conduit. The actuation connections transfer from the PLC 17 electrical signals to actuators and controllers of the mixing and pumping units and controllable valves. It is to be understood that the PLC 17 may also receive electrical signals from the actuation devices to be used to confirm they are operating properly and are receiving and obeying command signals. The PLC 17 is programmed to include one or more algorithms to calculate chemical treatment input requirements, including dilution values and flow rates, and to regulate mixing operations of the in-line mixers. The algorithms incorporate the information received from the meters and sensors. Additionally, the PLC 17 may receive manual instructions, such as override inputs, at the graphical user interface, to be incorporated into the algorithms used to establish chemical treatment input instructions.

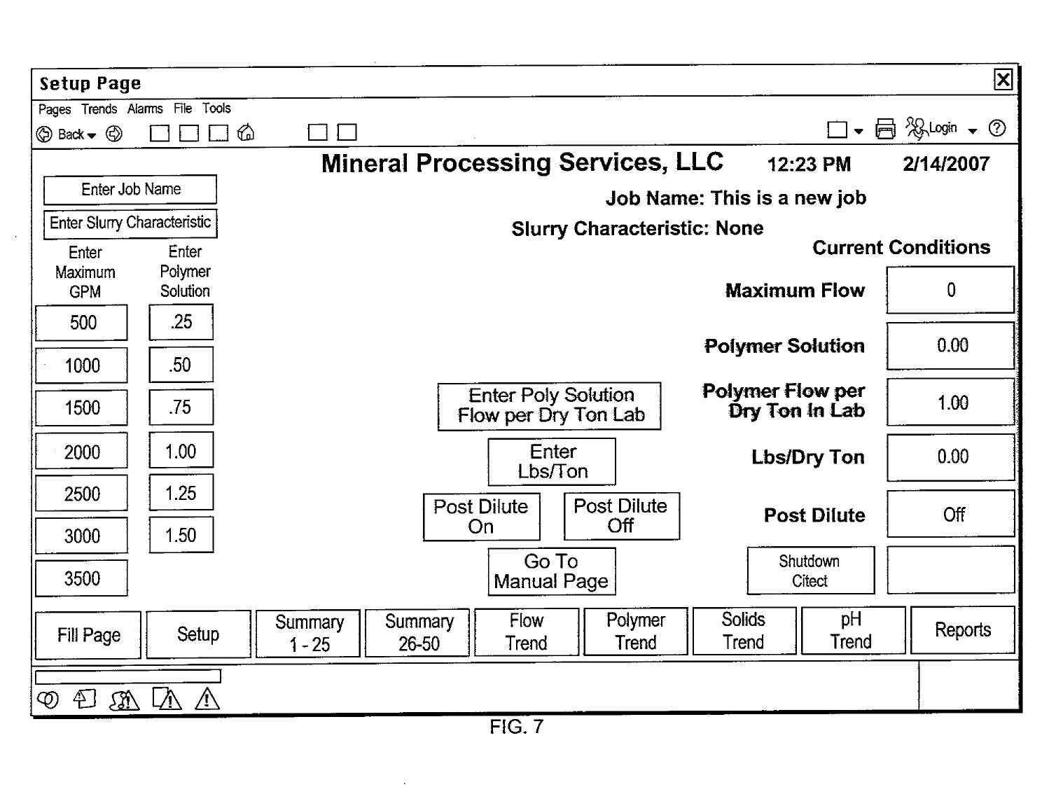

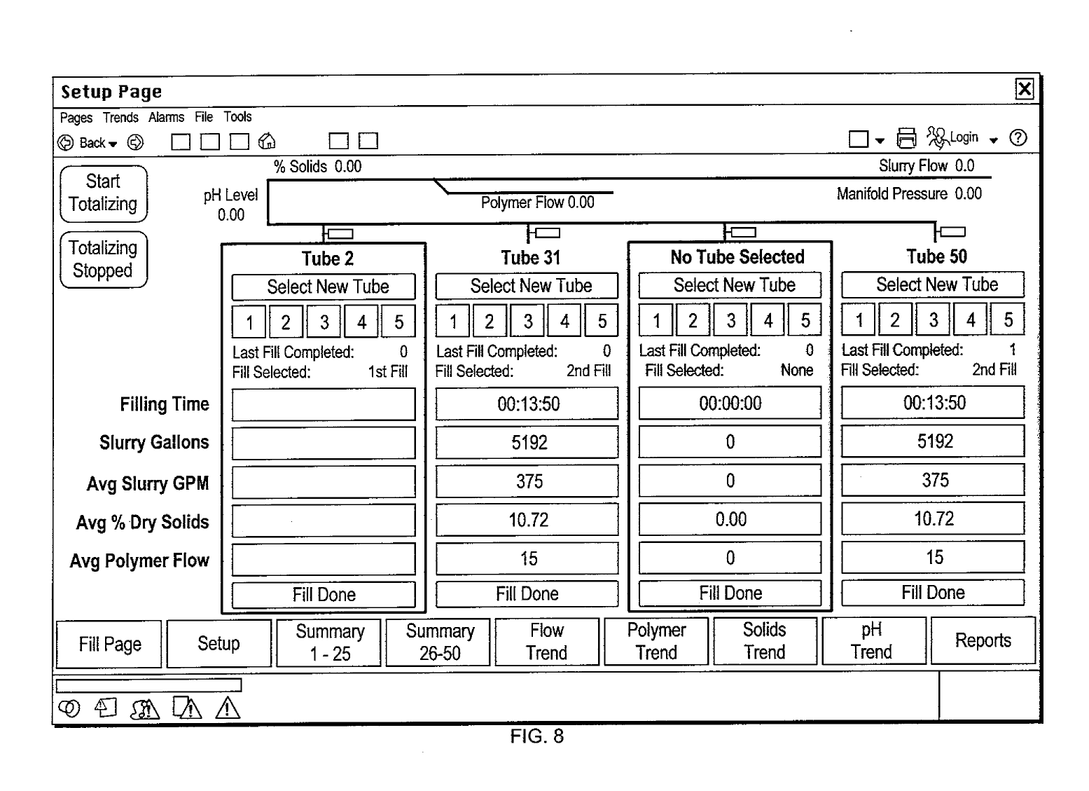

Examples of screen captures at the graphical user interface of the controller unit 16 are shown in FIGS. 7 and 8. In these example representations, it can be seen that the operator of the chemical treatment apparatus 10 is provided with graphical and text information of operating options, operating conditions and adjustment options. For example, the operator has the option to select the maximum untreated slurry input flow rate, the amount of chemical treatment to be added based on calculations made, and the current operating conditions of the continuous slurry flow. Additional screens may be called up to provide detailed information about particular aspects of the operation and to provide reports containing selectable information. It is to be noted that the controller unit 16 may be accessed locally or remotely to obtain operating condition information and/or to adjust operational conditions.

The PLC 17 is a computing system that may be programmed in the manner known to those of ordinary skill in the art. Specifically, the signals received by the PLC 17 or transmitted by the PLC 17 are computer-readable signals tangibly embodied on a computer-readable medium, including, but not limited to, wired or wireless exchange media. The present invention includes computer programming of the PLC 17, which computer programming defines instructions for processing data obtained from the meters and transmitted to the actuation devices. Such computer programming instructions may be written in any of a plurality of programming languages, including, by way of example only, Java, XML Visual Basic, C, or C++, Fortran, Pascal, Eiffel, Basic, COBOL, and the like, or any of a variety of combinations thereof. The computer-readable medium on which such instructions preferably reside is readable by the computing system embodied in the PLC 17.

The present invention has been described with respect to various combinations of preferred components. Nevertheless, it is to be understood that various modifications may be made without departing from the spirit and scope of the invention. Accordingly, other embodiments are within the scope of the claims appended hereto.

What is claimed is:

1. A chemical treatment apparatus comprising:
a. a conduit unit including an inlet for receiving an untreated slurry and an outlet for transferring treated slurry;
b. a chemical treatment unit coupled to the conduit unit for introducing one or more chemicals to the untreated slurry within the conduit unit;
c. one or more meters for detecting characteristics of the slurry within the conduit unit before and after introduction of the one or more chemicals; and
d. a controller unit coupled to the one or more meters and the chemical treatment unit, wherein the controller unit receives signals from the one or more meters indicative of the characteristics of the slurry within the conduit unit and transmits control signals to the chemical treatment unit to control introduction of the one or more chemicals to the untreated slurry.

2. The apparatus as claimed in claim 1 further comprising a chemical treatment mixing tank unit coupled to the chemical treatment unit for mixing the one or more chemicals prior to introduction to the conduit unit.

3. The apparatus as claimed in claim 1 wherein the conduit unit includes one or more in-line mixers.

4. The apparatus as claimed in claim 1 wherein the control unit includes a programmable logic controller.

5. The apparatus as claimed in claim 1 wherein the one or more meters include a slurry flow meter and a microwave dry solids meter.

6. The apparatus as claimed in claim 1 contained on a portable transport device.
